(19) United States
(12) Patent Application Publication
(10) Pub. No.: US 2014/0211705 A1
(43) Pub. Date: Jul. 31, 2014

(54) METHOD FOR DEVICE-TO-DEVICE COMMUNICATION BASED ON WIRELESS LOCAL AREA NETWORK AND APPARATUS FOR THE SAME

(71) Applicant: Electronics & Telecommunications Research Institute, Daejeon (KR)

(72) Inventor: Seung Kwon BAEK, Daejeon (KR)

(73) Assignee: Electronics & Telecommunications Research Institute, Daejeon (KR)

(21) Appl. No.: 14/165,787

(22) Filed: Jan. 28, 2014

(30) Foreign Application Priority Data
Jan. 28, 2013 (KR) 10-2013-0009182
Jan. 27, 2014 (KR) 10-2014-0009765

(51) Int. Cl. H04W 76/02; H04W 40/12; H04W 40/24

(52) U.S. Cl. CPC H04W 76/023; H04W 40/246; H04W 40/12
USPC 370/329

(57) ABSTRACT

Methods for device-to-device communication based on wireless local area network are disclosed. A method for device-to-device communications performed in a first terminal may comprise configuring a default bearer by interworking with a core network supporting cellular communication, configuring a session by interworking with the core network, discovering a counterpart terminal performing device-to-device communications with the first terminal based on a request of configuring a dedicated bearer, and configuring a communication path according to a communication mode determined based on a result of the discovering. Therefore, according to the present invention, D2D communications using a Wi-Fi P2P may be supported efficiently.

### CLAIM FOR PRIORITY

This application claims priority to Korean Patent Applications No. 10-2013-0009182 filed on Jan. 28, 2013 and No. 10-2014-0009765 filed on Jan. 27, 2014 in the Korean Intellectual Property Office (KIPO), the entire contents of which are hereby incorporated by reference.

### BACKGROUND

1. Technical Field

Example embodiments of the present invention relate in general to a technique of direct communications (device-to-device communications) between terminals, and more specifically, to a method of direct communications between terminals and an apparatus for the same.

2. Related Art

In a cellular communication environment, a general method for terminals to exchange data each other is a communication via a base station. That is, if a first terminal has data to be transmitted to a second terminal, the first terminal transmits the data to a first base station to which the first terminal is attached at first. Then, the first base station transmits the data received from the first terminal to a second base station to which the second terminal is attached via a core network (CN). At last, the second base station transmits the data received from the first base station to the second terminal. Here, the first base station and the second base station may be the same base station or different base stations.

Meanwhile, direct communications between terminals (hereinafter, a term ‘device-to-device (D2D) communication’ may be used alternatively) mean a communication manner that direct data exchange between adjacent terminals is performed without an intervention of a base station. That is, each of two terminals performs communications with each other by acting as data source and data destination to a counterpart terminal.

The D2D communications may be classified into D2D communications based on a cellular network and D2D communications based on a wireless local area network (WLAN). The D2D communications based on a cellular network means a case in which terminals communicates with each other by using a cellular communication manner, and the D2D communication based on a WLAN means a case in which terminals communicates with each other by using a WLAN communication manner.

Among the D2D communications, a structure of system and operation procedures for supporting the D2D communications based on a WLAN have not been defined specifically.

### SUMMARY

Accordingly, example embodiments of the present invention are provided to substantially obviate one or more problems due to limitations and disadvantages of the related art.

Example embodiments of the present invention provide methods for supporting D2D communications using a Wi-Fi peer-to-peer (P2P) mode.

In some example embodiment, a method for device-to-device communications performed in a first terminal may comprise configuring a default bearer by interworking with a core network supporting a cellular communication; configuring a session by interworking with the core network; discovering a counterpart terminal performing device-to-device communications with the first terminal based on a request of configuring a dedicated bearer; and configuring a communication path according to a communication mode determined based on a result of the discovering.

Here, the session may be configured based on a session initiation protocol (SIP).

Here, the first terminal may discover the counterpart terminal performing device-to-device communications with the first terminal based on a cellular communication manner.

Here, the first terminal may discover the counterpart terminal performing device-to-device communications with the first terminal based on a wireless local area network (WLAN) peer-to-peer (P2P) communication manner.

Here, the communication path may be configured with the dedicated bearer for the cellular communication when the communication mode is a cellular communication mode.

Here, the communication path may be configured with a link for a wireless local area network (WLAN) peer-to-peer (P2P) communication when the communication mode is a WLAN P2P mode.

Also, the method may further comprise measuring a communication quality of the link; requesting a change of the communication path to a device-to-device server located in the core network when the communication quality is below a predetermined threshold; and changing the communication path from the link for the WLAN P2P to the dedicated bearer for the cellular communication by interworking with the core network.

In other example embodiment, a method for device-to-device communication performed in a first terminal may comprise configuring a default bearer by interworking with a core network supporting cellular communication; configuring a session and a dedicated bearer by interworking with the core network; discovering a counterpart terminal performing device-to-device communications with the first terminal based on a request of discovery; and configuring a link for wireless local area network peer-to-peer communications with the counterpart terminal when a communication mode determined according to a result of the discovering is a wireless local area network peer-to-peer communication mode.

Here, the first terminal may discover the counterpart terminal performing device-to-device communications with the first terminal based on a cellular communication manner.

Here, the first terminal may discover the counterpart terminal performing device-to-device communications with the first terminal based on a wireless local area network (WLAN) peer-to-peer (P2P) communication manner.

Here, the method may further comprise measuring a communication quality of the link; and changing the communication path from the link for the WLAN P2P to the dedicated bearer for the cellular communication when the communication quality is below a predetermined threshold.

In still other example embodiment, a method for device-to-device communication performed in a first terminal may comprise configuring a default bearer by interworking with a core network supporting cellular communication; configuring a first session and a first dedicated bearer by interworking with the core network; configuring a second session by interworking with the core network; discovering a counterpart terminal performing device-to-device communications with the first terminal based on a request of configuring a second dedicated bearer; and configuring a communication path according to a communication mode determined based on a result of the discovering.

Here, the first terminal may discover the counterpart terminal performing device-to-device communications with the first terminal based on a cellular communication manner.

Here, the first terminal may discover the counterpart terminal performing device-to-device communications with the first terminal based on a wireless local area network (WLAN) peer-to-peer (P2P) communication manner.

Here, the communication path may be configured with the dedicated bearer for the cellular communication when the communication mode is a cellular communication mode.

Here, the communication path may be configured with a link for a wireless local area network (WLAN) peer-to-peer (P2P) communication when the communication mode is a WLAN P2P mode.

Here, the method may further comprise measuring a communication quality of the link; and changing the communication path from the link for the WLAN P2P to the second dedicated bearer for the cellular communication when the communication quality is below a predetermined threshold.

In still other example embodiment, a method for device-to-device communication performed in a first terminal may comprise configuring a default bearer by interworking with a core network supporting cellular communication; configuring a session and a dedicated bearer by interworking with the core network; discovering a counterpart terminal performing device-to-device communications with the first terminal when a traffic load of the cellular communication is equal to or above a predetermined threshold; and configuring a link for wireless local area network peer-to-peer communications with the counterpart terminal when a communication mode determined according to a result of the discovering is a wireless local area network peer-to-peer communication mode.

Here, the method may further comprise measuring a communication quality of the link; and changing the communication path from the link for the WLAN P2P to the dedicated bearer for the cellular communication when the communication quality is below a predetermined threshold.

Here, the method may further comprise changing the communication path from the link for the WLAN P2P to the dedicated bearer for the cellular communication when a traffic load of the cellular communication is below a predetermined threshold.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to illustrate communication modes for a terminal and a traffic session;

FIG. 2 is a block diagram to illustrate a structure of interworking and logical reference points between functional entities for WLAN ProSe;

FIG. 3 is a block diagram to illustrate a protocol structure for functional entities for WLAN ProSe;

FIG. 4 is a flow chart to illustrate a first configuration procedure for Wi-Fi P2P communication;

FIG. 5 is a flow chart to illustrate a second configuration procedure for Wi-Fi P2P communication;

FIG. 6 is a flow chart to illustrate a third configuration procedure for Wi-Fi P2P communication;

FIG. 7 is a flow chart to explain a first operation procedure of ProSe assisted WLAN direction communication according to an example embodiment;

FIG. 8 is a flow chart to explain a second operation procedure of ProSe assisted WLAN direction communication according to an example embodiment;

FIG. 9 is a flow chart to explain a third operation procedure of ProSe assisted WLAN direction communication according to an example embodiment;

FIG. 10 is a flow chart to explain a first configuration procedure for a Wi-Fi P2P communication according to the present invention;

FIG. 11 is a flow chart to explain a second configuration procedure for a Wi-Fi P2P communication according to the present invention;

FIG. 12 is a flow chart to explain a third configuration procedure for a Wi-Fi P2P communication according to the present invention;

FIG. 13 is a flow chart to explain a first operation procedure for management and continuity of services of a ProSe assisted WLAN direct communication according to the present invention;

FIG. 14 is a flow chart to explain a second operation procedure for management and continuity of services of a ProSe assisted WLAN direct communication according to the present invention;

FIG. 15 is a flow chart to explain a third operation procedure for management and continuity of services of a ProSe assisted WLAN direct communication according to the present invention;

FIG. 16 is a flow chart to explain a first simultaneous operation procedure for an E-UTRAN infrastructure mode and a WLAN ProSe mode according to the present invention;

FIG. 17 is a flow chart to explain a second simultaneous operation procedure for an E-UTRAN infrastructure mode and a WLAN ProSe mode according to the present invention;

FIG. 18 is a flow chart to explain a first operation procedure for network offloading through a WLAN ProSe communication according to the present invention; and

FIG. 19 is a flow chart to explain a second operation procedure for network offloading through a WLAN ProSe communication according to the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of the figures, and the same elements will not be described further.

In this specification, a configuration of system and operation procedures for supporting WLAN proximity service (ProSe) use cases using Wi-Fi peer-to-peer (P2P) mode among ProSe use cases defined in 3^{rd} generation partnership project (3GPP) will be explained.

There are four use cases in connection with the WLAN ProSe as follows.

(1) ProSe-Assisted WLAN Direct Communication
The first use case means a scenario in which terminals with functions of ProSe communicates with each other based on WLAN direct communication manner.
Requirements: A terminal with a function of WLAN should be located in a WLAN-capable area, and it is possible that the terminal performs a WLAN direct communication using WLAN configuration information provided by a 3GPP evolved packet system (EPS) according to user preferences and policies of a mobile network operator (MNO).

(2) Service Management and Continuity for ProSe-Assisted WLAN Direct Communication
The second use case means a scenario in which terminals with functions of ProSe is provided with service continuity between a WLAN direct communication and an infrastructure communication.
Requirements: Flexible mobility of traffic flows should be possible in providing the service continuity between a WLAN direct communication and an infrastructure communication. Also, the conventional 3GPP radio access network (RAN) should not be affected by this procedure.

(3) Performing Evolve Universal Terrestrial Radio Access Network (E-UTRAN) Infrastructure Communication and WLAN ProSe Communication at the Same Time
The third use case means a scenario in which a WLAN direct communication and an infrastructure communication are performed simultaneously.
Requirements: A 3GPP EPS should manage a WLAN direct communication and an infrastructure communication at the same time. Also, it should be possible that a new session can be configured by using the infrastructure mode during WLAN ProSe communications.

(4) Network Offloading Through WLAN ProSe Communication
The fourth use case means a scenario in which offloading data of a cellular network is provided by using WLAN ProSe communication.
Requirements: A 3GPP EPS can perform a procedure of switching a communication path for a terminal or a specific session of a terminal from a path using a cellular communication to a path using a WLAN ProSe according to load of the 3GPP network.

According to the use cases explained above, required functions to be provided by an Evolved Packet System (EPS) may be categorized as follows. System configurations and procedures for providing the following functions are required to be defined.
Connection establishment
Connection maintenance
Service continuity

Then, a functional structure for supporting use cases related to the 3GPP ProSe will be explained. For this, communication modes which a terminal can use based on techniques being considered in 3GPP, and a functional structure of 3GPP Long Term Evolution (LTE) for WLAN ProSe are explained.

In connection with the WLAN and the ProSe, communication modes which are considered in a 3GPP LTE system may be classified as a below table 1. These communication modes may be independently applied to a specific terminal and a specific traffic session configured in a terminal.

TABLE 1

| Communication mode | Description |
|---|---|
| LTE infrastructure | A form in which a terminal communicates with |
| mode | a counterpart terminal or a counterpart node |
| | by using eNB(s), MME, S-GW, and PGW of a |
| | LTE system based on E-UTRAN |
| Non-trust Non-3GPP | A form in which a terminal communicates with |
| access mode | a counterpart terminal or a counterpart node |
| (I-WLAN mode) | by using WLAN based WLAN IP access, ePDG, |
| | and P-GW |
| E-UTRA ProSe mode | A form in which a terminal directly |
| | communicates with a counterpart terminal by |
| | using E-UTRA, or a terminal communicates |
| | with a counterpart terminal via eNB |
| WLAN ProSe mode | A form in which a terminal directly |
| | communicates with a counterpart terminal by |
| | using Wi-Fi P2P |

Communication modes explained above may be operated in various forms according to at least one of preferences of users, policies of a mobile network operator (MNO), states of networks, etc.

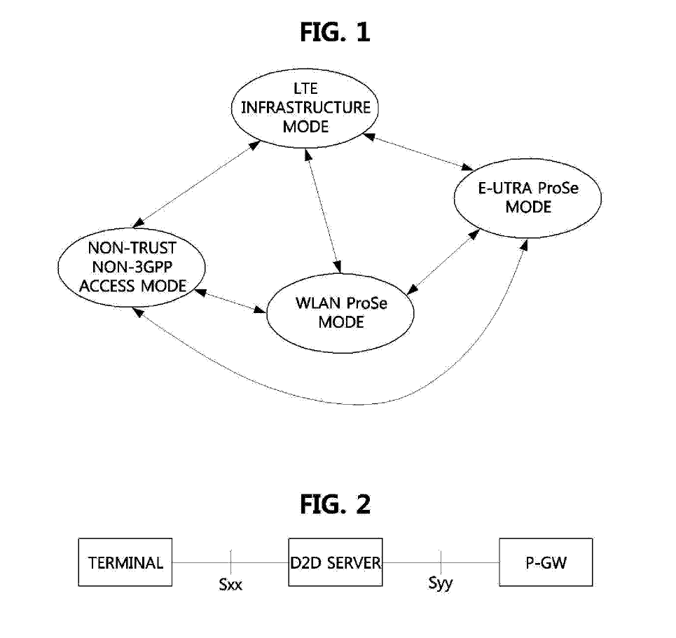

FIG. 1 is a conceptual diagram to illustrate communication modes for a terminal and a traffic session.

Referring to FIG. 1, a communication mode can be transitioned to one of other communication modes. For example, the LTE infrastructure mode can be transitioned to one of the non-trust non-3GPP access mode, the E-UTRA ProSe mode, and the WLAN ProSe mode. Also, the non-trust non-3GPP access mode can be transitioned to one of the LTE infrastructure mode, the E-UTRA ProSe mode, and the WLAN ProSe mode. Also, the E-UTRA ProSe mode can be transitioned to one of the LTE infrastructure mode, the non-trust non-3GPP access mode, and the WLAN ProSe mode. Also, the WLAN ProSe mode can be transitioned to one of the LTE infrastructure mode, the non-trust non-3GPP access mode, and the E-UTRA ProSe mode.

Meanwhile, a terminal does not operate only in a specific communication mode explained in FIG. 1, but the terminal may operate in various communication modes according to traffic sessions configured in the terminal.

Then, a functional structure for supporting use cases based on the LTE infrastructure mode among communication modes of a 3GPP system and the WLAN ProSe mode will be explained. For this, new functional entities such as a D2D server and a D2D client are introduced, and functions for WLAN ProSe may be provided by cooperation between these functional entities and the conventional LTE and EPS functional entities.

The D2D server may be a functional entity located in the EPS for the WLAN ProSe service, operate with logical reference points to a packet data network gateway (P-GW) and a terminal, and perform the following functions for supporting the WLAN ProSe mode.
Storing/Managing WLAN ProSe configuration information
Controlling WLAN ProSe service by interworking with a D2D client of a terminal
   Activation/deactivation of Wi-Fi P2P, Receiving measurement report
Controlling WLAN ProSe service according to requests of users or a MNO by interworking with P-GW and reporting events
Generating and managing a proximity map indicating proximities between terminals

The D2D client may be a functional entity which is located in a terminal and provides the ProSe service by interworking with the D2D server, and operate with logical reference points to the D2D server. The D2D client may perform the following functions for supporting the WLAN ProSe mode.
Exchanging configuration information for the WLAN ProSe service by interworking with the D2D server
Controlling functions of Wi-Fi P2P (for example, activation/deactivation and measurement report) using the WLAN ProSe configuration information provided by the D2D server.

The P-GW may mean a functional entity located in an EPS of LTE network, and operate with logical reference points to the D2D server. The P-GW may perform the following functions for supporting the WLAN ProSe mode.
Requesting establishment and release of the WLAN ProSe service according to states of a MNO and a 3GPP network by interworking with the D2D server
Exchanging control information for the WLAN ProSe service by interworking with functional entities of a 3GPP LTE network (for example, a policy control rule function (PCRF))

FIG. 2 is a block diagram to illustrate a structure of interworking and logical reference points between functional entities for WLAN ProSe.

Referring to FIG. 2, a terminal may be connected to the D2D server through a Sxx interface, and the D2D server may be connected to the P-GW through a Syy interface.

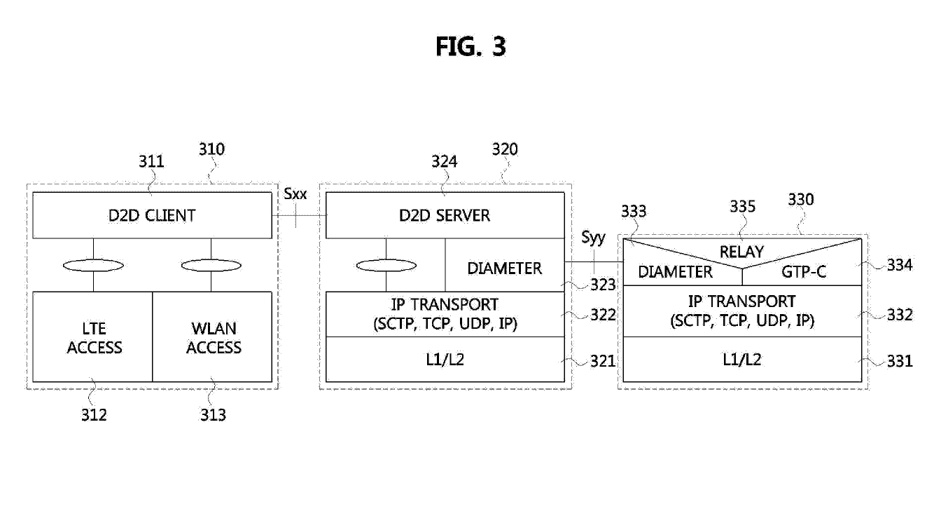

FIG. 3 is a block diagram to illustrate a protocol structure for functional entities for WLAN ProSe.

Referring to FIG. 3, a terminal 310 may comprise a D2D client layer 311, a LTE access layer 312, and a WLAN access layer 313. The D2D server 320 may comprise a L1/L2 layer 321, an internet protocol (IP) transport layer 322, a diameter layer 323, and a D2D server layer 324. Here, the D2D client layer 311 and the D2D server layer 324 may be connected through the Sxx interface.

The P-GW 330 may comprise a L1/L2 layer 331, an IP transport layer 332, a diameter layer 333, a GPRS tunneling protocol-control plane (GTP-C) layer 334, and a relay layer 335. Here, the diameter layer of the P-GW and the diameter layer of the D2D server may be connected through the Syy interface.

Also, the IP transport layers 322 and 332 may mean a stream control transmission protocol (SCTP), a transmission control protocol (TCP), an user datagram protocol (UDP), an internet protocol (IP), and so on.

Then, information needed in a 3GPP system for WLAN ProSe and a functional entity of 3GPP LTE system which manages the information will be explained.

Procedures for Wi-Fi P2P communications may be classified into a procedure of scanning/discovering and a procedure of forming groups. The Wi-Fi P2P communications may be started after a completion of the above procedures. Especially, the procedure of scanning/discovering means a procedure of scanning a counterpart terminal which will perform communications with a terminal, and procedures defined in a Wi-Fi P2P standard specification may be used for the procedure of scanning/discovering. After a completion of the procedure of scanning/discovering, the procedure of forming groups which will perform communications, and configuring a group owner (GO) for each of the groups is performed, and so the procedures for Wi-Fi P2P communications may be completed. After a completion of the procedures for Wi-Fi P2P communications, terminals included in a group may perform D2D communications under control of a GO of the group.

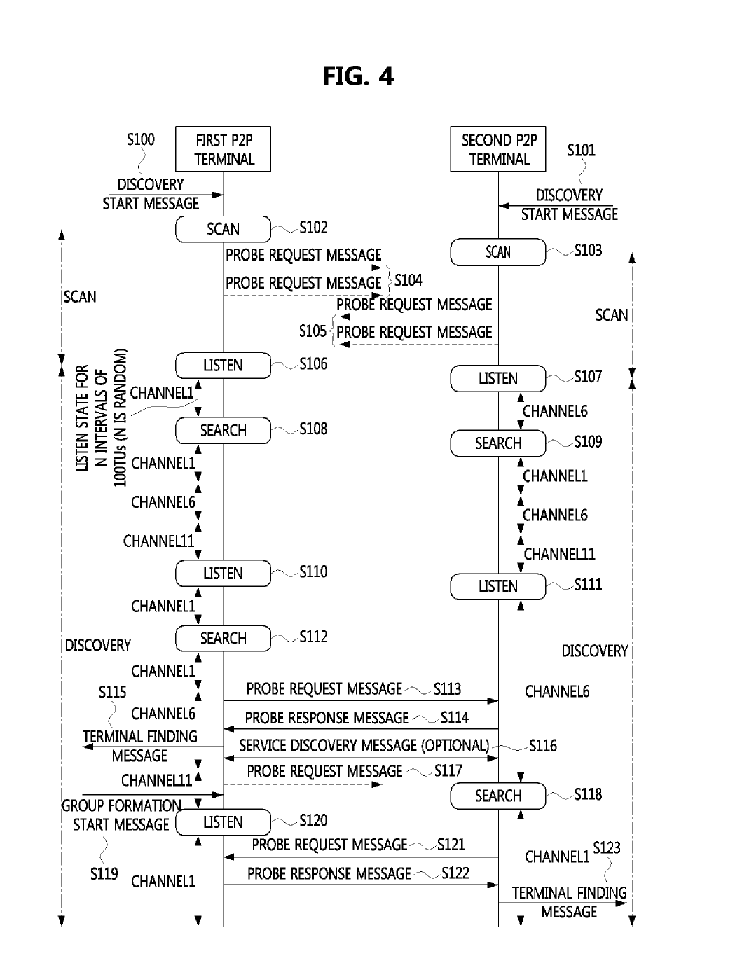

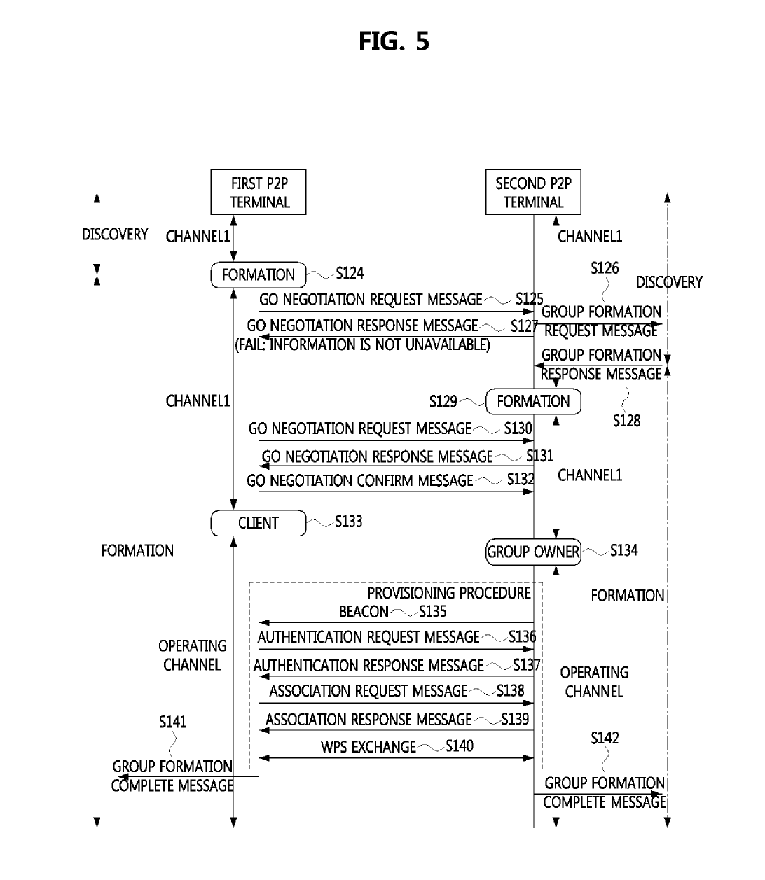

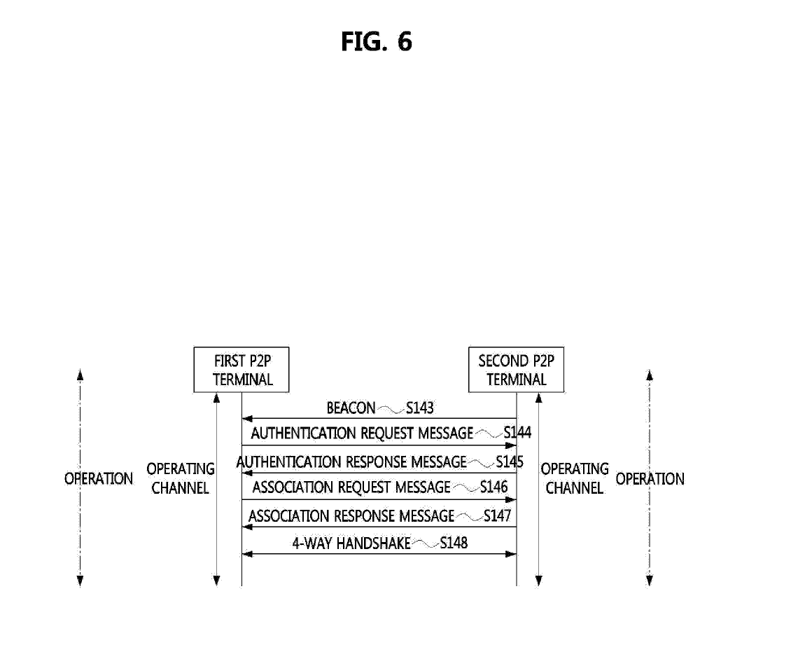

FIG. 4 is a flow chart to illustrate a first configuration procedure for Wi-Fi P2P communication, FIG. 5 is a flow chart to illustrate a second configuration procedure for Wi-Fi P2P communication, and FIG. 6 is a flow chart to illustrate a third configuration procedure for Wi-Fi P2P communication.

Referring to FIGS. 4 to 6, when a first P2P terminal and a second P2P terminal receive a discovery start message from an arbitrary communication entity (at S100 and S101), the first P2P terminal and the second P2P terminal may perform a procedure of scanning (at S102 and S103). In the procedure of scanning, each of the P2P terminals may transmit at least one probe request message (at S104 and S105).

After the procedure of scanning, each of the P2P terminals may perform a procedure of discovery. In the procedure of discovery, each of P2P terminals may discover a counterpart P2P terminal in listen states (at S106, S107, S110, S111, and S120) and in search states (at S108, S109, S112, and S118). For example, the first P2P terminal may discover a counterpart P2P terminal (that is, the second P2P terminal) by transmitting a probe request message in a search state (at S113), and receiving a probe response message in response to the probe request message (at S114). When the counterpart P2P terminal is discovered, the first P2P terminal may transmit a device finding message indicating that the counterpart P2P terminal is discovered to an arbitrary communication entity (at S115).

Similarly, the second P2P terminal may discover a counterpart P2P terminal (that is, the first P2P terminal) by transmitting a probe request message in a search state (at S121), and receiving a probe response message in response to the probe request message (at S122). When the counterpart P2P terminal is discovered, the second P2P terminal may transmit a device finding message indicating that the counterpart P2P terminal is discovered to an arbitrary communication entity (at S123).

On the other hand, when a counterpart P2P terminal is discovered, each of the P2P terminals and a counterpart P2P terminal may transmit service discovery messages for discovering P2P services to each other (at S116). A procedure of transmitting and receiving service discovery messages may be an optional procedure.

After the procedure of discovery, each of the P2P terminals may perform a procedure of forming groups. The first P2P terminal may form groups (at S124) when a group formation start message is received from an arbitrary communication entity (at S119), and transmit a GO negotiation request message to the second P2P terminal for configuring a group owner (GO) (at S125). When the second P2P terminal receives the GO negotiation request message, the second P2P terminal may transmit a group formation request message to an arbitrary communication entity (at S126). Also, since a group is not formed yet, the second P2P terminal may transmit a GO negotiation response message indicating that negotiation for configuring a GO cannot be performed to the first P2P terminal (at S127).

Then, the second P2P terminal may receive a group formation response message in response to the group formation request message (at S128), and may form a group based on the group formation response message (at S129).

The first P2P terminal may transmit again a GO negotiation request message to the second P2P terminal (at S130). Since a group has been formed, in response to the GO negotiation request message, the second P2P terminal may transmit a GO negotiation response message indicating that negotiation for configuring a GO can be performed to the second P2P terminal (at S131). The first P2P terminal may transmit a GO negotiation confirm message in response to the GO negotiation response message to the second P2P terminal (at S132). Through the above described procedures, the first P2P terminal may be configured as a client (at S133), and the second P2P terminal may be configured as a GO (at S134).

Then, the first P2P terminal and the second P2P terminal may perform a provisioning procedure in operating channel. Especially, the second P2P terminal may transmit a beacon (at S135). When the beacon is received, the first P2P terminal may transmit an authentication request message to the second P2P terminal (at S136), and the second P2P terminal which received it may transmit an authentication response message in response to the authentication request message to the first P2P terminal (at S137).

After the authentication, the first P2P terminal may transmit an association request message to the second P2P terminal (at S138). When the second P2P terminal receives the association request message, it may transmit an association response message in response to the association request message to the first P2P terminal (at S139). After a completion of the association, the first P2P terminal and the second P2P terminal may exchange Wi-Fi protected setup (WPS) messages (at S140).

After the above described procedures are completed, each of the P2P terminals may transmit a group formation complete message indicating that formation of a group is completed to an arbitrary communication entity (at S141 and S142).

After a completion of the procedure of forming groups, each of the P2P terminals may an operation procedure. Especially, the second P2P terminal may transmit a beacon (at S143). When the beacon is received, the first P2P terminal may transmit an authentication request message to the second P2P terminal (at S144), and the second P2P terminal which received it may transmit an authentication response message in response to the authentication request message to the first P2P terminal (at S145).

After the authentication, the first P2P terminal may transmit an association request message to the second P2P terminal (at S146). When the second P2P terminal receives the association request message, it may transmit an association response message in response to the association request message to the first P2P terminal (at S147). After the association, the first P2P terminal and the second P2P terminal may perform a final authentication procedure through a four-way handshake procedure (at S148).

In order to provide the WLAN ProSe service, functions for managing information used in the above described procedure of configuring Wi-Fi P2P communication, and functions for supporting flexible WLAN ProSe services by transferring the information from a D2D server of an EPS to a terminal are needed. For this, methods of managing configuration information of the WLAN ProSe may be classified into a method of a loose management and a method of a tight management. The above classification may be explained as follows according to a range of configuration parameters managed in a 3GPP network for Wi-Fi P2P service.
A method of a loose management
Managing configuration parameters needed for the procedure of scanning/discovering for Wi-Fi P2P and an IP address of a terminal, and providing a WLAN ProSe service based on the parameters and IP address.
A method of a tight management
Managing the configuration parameters managed in the method for a loose management and configuration parameters needed for forming P2P groups, and providing a WLAN ProSe service based on the parameters.
The configuration information does not include permanent group configuration information. For the permanent group configuration, information stored in a terminal may be used.

There are advantages and disadvantages respectively in the methods of the loose management and the tight management as follows.
A method of a loose management
Advantages: small amount of information managed in a 3GPP network, and little effect on controlling operation procedures of Wi-Fi P2P as compared to the method of the tight management.
Disadvantages: much time required to perform configuration procedures of Wi-Fi P2P communications as compared to the method of the tight management.
A method of a tight management
Advantages: smaller time required to perform configuration procedures of Wi-Fi P2P communications as compared to the method of the loose management.
Disadvantages: larger amount of information managed in a 3GPP network and large effect on controlling operation procedures of Wi-Fi P2P are demanded as compared to the method of the tight management since detail configuration parameters defined in a Wi-Fi P2P standard specification should be managed.

In order to meet requirements of the WLAN ProSe based on the above explained methods, procedures of managing parameters needed for the procedures of configuring Wi-Fi P2P in the D2D server of the EPS and procedures of exchanging corresponding parameters according to a respective scenario are necessary.
A procedure of scanning/discovering
In the procedure of scanning/discovering, a procedure of exchanging information between terminals using management frames, which are defined in an IEEE 802.11-2007 standard specification, and additional information elements (IEs) related to Wi-Fi P2P are added to, is performed. The information included in them is required to be managed by an EPS.
Management frames used in the procedure of scanning/discovering
   Beacon frame
   Probe request frame
   Probe response frame
Demanded configuration information
   P2P device ID (6 byte address)
   Device Name (Max 32 bytes; SSID (service set identifier))
   Information about frequency bands and channel for configuration of Wi-Fi (P2P—Regulatory class, channel number list)
A procedure of forming groups
In the procedure of forming groups, a procedure of exchanging information between terminals is performed by using P2P public action frames defined in a Wi-Fi P2P standard specification. Configuration information included in the information is required to be managed by an EPS. The public action frames are frames used for transferring information for generic advertisement service (GAS) in IEEE 802.11u, and management frames based on structures of the public action frames are used in the Wi-Fi P2P specification.
   Public action frames used for the procedure of forming groups
      GO negotiation request message
      GO negotiation response message
      GO negotiation confirm message
   Demanded configuration information
      GO intent: information used in negotiation of configuring a GO (When an EPS determines a GO and a client in forming groups, the EPS transfer this information to a terminal)
   WPS provisioning information
      IP address
      Credential (an authentication type, an encryption type, and a network key)

Based on the above description, information for supporting WLAN ProSe service in a 3GPP LTE system and functional entities in an EPS managing the information are shown in a following table 2.

TABLE 2

| Functional | Information for WLAN | | |
|---|---|---|---|
| Entities | ProSe | Description | Remarks |
| HSS | Radio access capability | Radio access capability of a terminal | |
| PCRF | User preference on a | User preference on whether to use a | |
| | use of WLAN ProSe | WLAN ProSe or not | |
| | Support of load | User preference on whether to use load | |
| | balancing using WLAN | balancing based on WLAN ProSe or | |
| | ProSe | not | |
| | Rules for using WLAN | Policies and rules of a MNO on uses of | |
| | ProSe | WLAN ProSe | |
| P-GW | RAT type for EPS | RAT(Radio Access Technology) used | |
| | bearer | currently for each EPS bearer | |
| | Operation mode for | Operation mode used currently for | Refer to |
| | EPS bearer | each EPS bearer | Table 1 |
| | QoS information for | QoS information for each EPS bearer | |
| | EPS bearer | | |
| | IP address | IP address of a terminal | |
| D2D | ProSe discovery ID | Identifier for ProSe service | |
| server | Terminal ID | Identifier of a terminal | |
| (for each | SSID | Name of a WLAN device in a terminal | 0~32 bytes |
| terminal) | P2P device ID | WLAN ID of a terminal | 6 bytes |
| | GO indicator | Information indicating a GO | Used in a |
| | | | tight |
| | | | management |
| | Credentials for Wi-Fi | Information related credential which is | Used in a |
| | P2P | used in a terminal (authentication | tight |
| | | type, encryption type, network key) | management |

Hereinafter, operation procedures for supporting use cases for WLAN ProSe based on the above explained functional entities and configuration information will be explained.

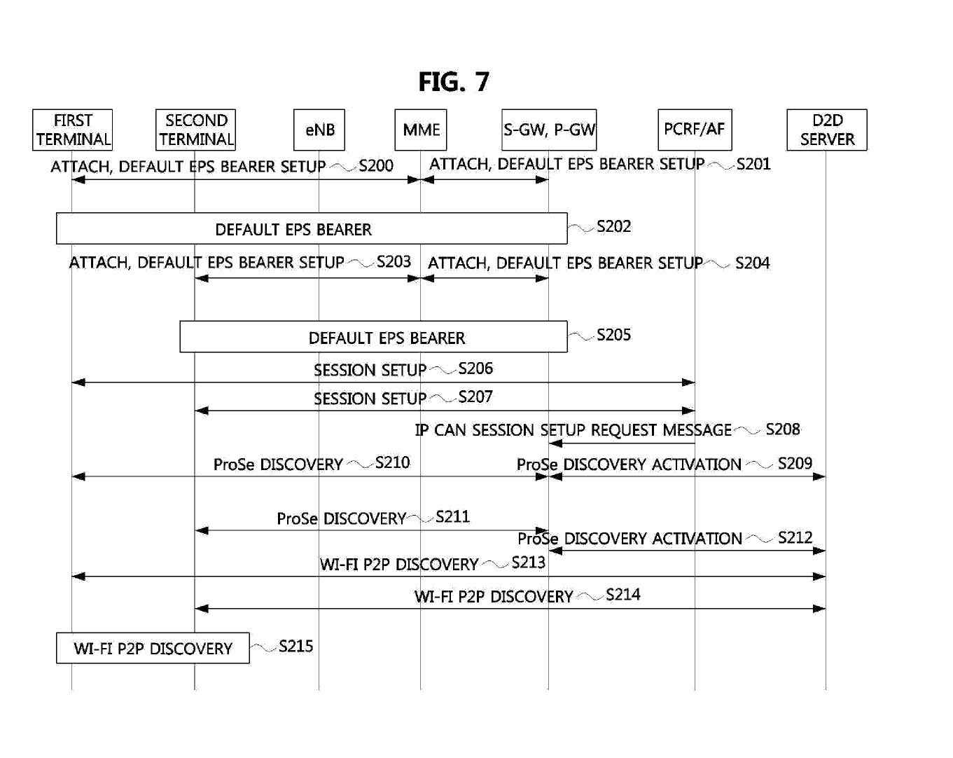

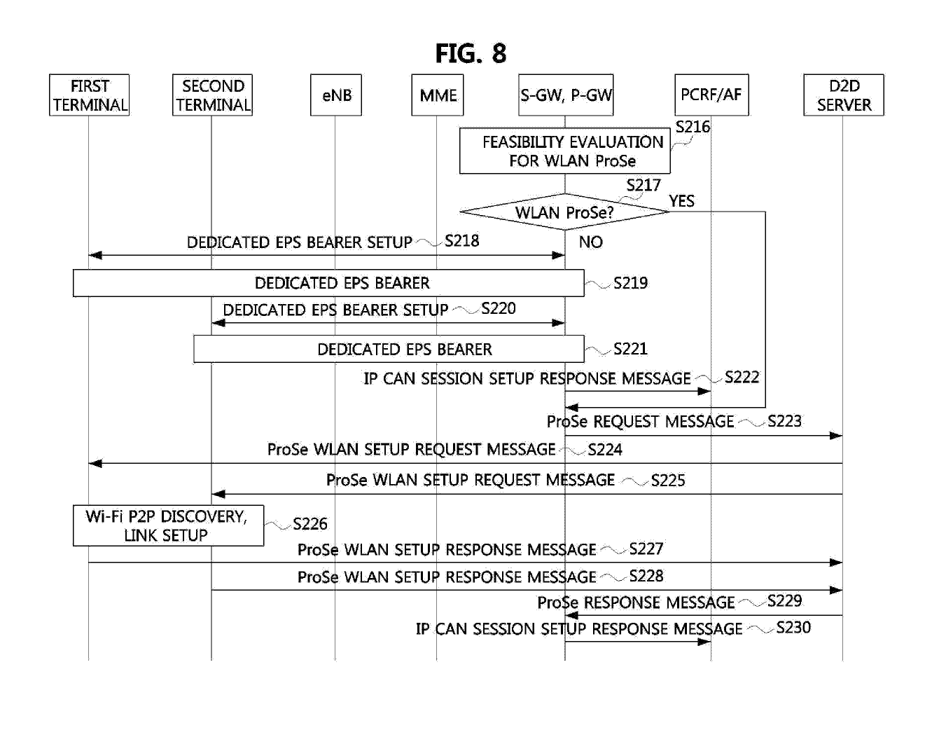

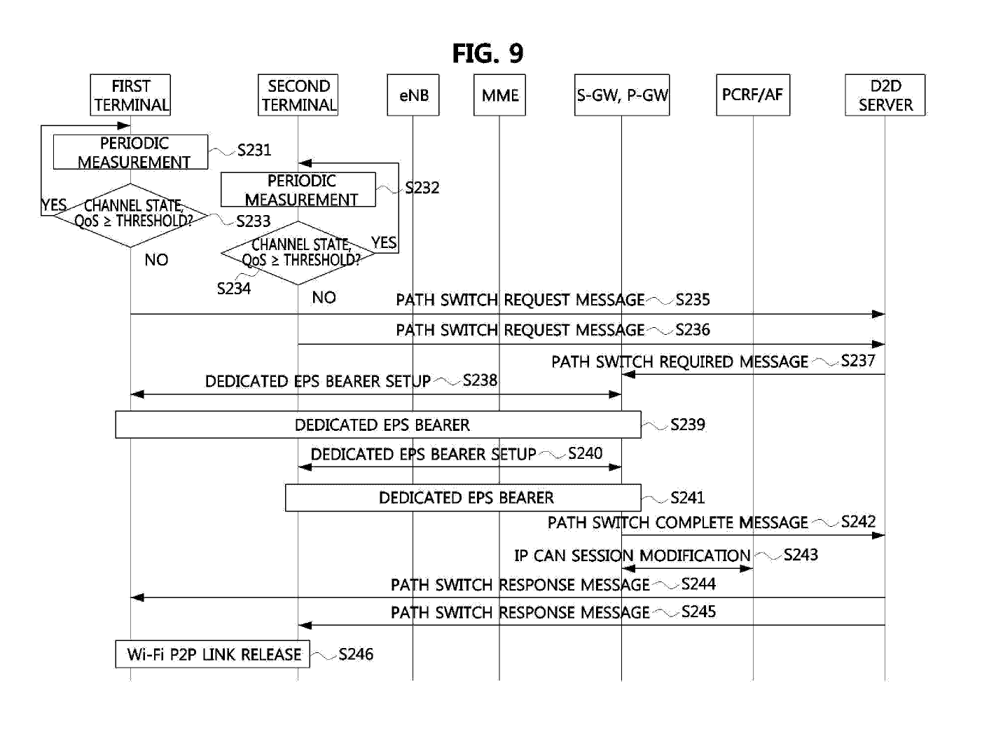

FIG. 7 is a flow chart to explain a first operation procedure of ProSe assisted WLAN direction communication according to an example embodiment, FIG. 8 is a flow chart to explain a second operation procedure of ProSe assisted WLAN direction communication according to an example embodiment, and FIG. 9 is a flow chart to explain a third operation procedure of ProSe assisted WLAN direction communication according to an example embodiment.

Referring to FIGS. 7 to 9, a first terminal means a terminal initiating WLAN ProSe service, and a second terminal means a terminal performing WLAN ProSe service according to the indication of the first terminal. The operation procedures mean procedures of performing a specific service or overall services by using WLAN ProSe when the first terminal and the second terminal are registered.

Procedures of attachment and configuration of a default EPS bearer The first terminal may perform a procedure of initial registration (or, service request) and configuring a default EPS bearer by interworking with a MME and a P-GW (at S200 and S201). Through this, a default EPS bearer for the first terminal may be configured (at S202).

Similarly, the second terminal may perform a procedure of initial registration (or, service request) and configuring a default EPS bearer by interworking with a MME and a P-GW (at S203 and S204). Through this, a default EPS bearer for the second terminal may be configured (at S205).

Procedures of Configuring an IP-Level Session

After the default EPS bearer is configured, the first terminal and the second terminal may configure a session with a PCRF/AF (application function) based on an IP-level protocol such as a session initiation protocol (SIP) (at S206 and S207). In this case, the first terminal may perform a procedure of session configuration by interworking with the second terminal.

A Procedure of Requesting a Dedicated EPS Bearer Configuration

Then, the PCRF may transmit an IP connectivity access network (CAN) session configuration request message to the P-GW in order to request configuration of a dedicated EPS bearer according to the IP-level session configuration request (at S208). Here, the PCRF may request the configuration of a dedicated EPS bearer to the P-GW in consideration of requests of AF, policies of the PCRF, etc. The request of configuration of a dedicated EPS bearer transmitted from the PCRF to the P-GW may include information which will be describe below based on user preferences related to WLAN ProSe and policies of a MNO in addition to parameters of a conventional 3GPP LTE system.
Operation policies
   Configured based on user preferences for use of WLAN ProSe, usage policies of WLAN ProSe by a MNO, and a support of load balancing for WLAN ProSe, which are stored in the PCRF
   Whether a change of a path to WLAN ProSe is possible or not when a traffic congestion occurs in a LTE network
   For example, a dedicated infrastructure mode, an infrastructure mode, or a WLAN ProSe mode, etc.

A Procedure of D2D Discovery

After the procedure of requesting a dedicated EPS bearer configuration, the procedure of D2D discovery may be performed. The procedure of D2D discovery means a procedure of measuring a proximity between two terminals (that is, the first terminal and the second terminal) desiring to perform a ProSe service, and may be performed by the D2D server according to a request of the P-GW. The procedure of D2D discovery may be classified into two types. A first type is a type of performing measurement through a ProSe discovery using E-UTRA and estimation of proximity between two terminals based on the measurement. The second type is a type of using a peer discovery of Wi-Fi P2P.

Here, in a case that the proximity between the terminals is measured by the first type, the proximity is proximity between nodes measured by using E-UTRA not proximity measured using channels of Wi-Fi P2P. Therefore, the D2D server should estimate proximity on channels of Wi-Fi P2P by using a result obtained through the ProSe discovery.

First, the first type of D2D discovery procedure is explained. The P-GW which receives a dedicated EPS bearer configuration request from the PCRF may activate a ProSe discovery by interworking with the D2D server (at S209). Then, the P-GW may measure proximity between the first terminal and the second terminal which will perform communications using E-UTRA (at S210 and S211).

Specifically, a procedure of ProSe discovery is configured to configure discovery channels for measuring proximity according to the request of the P-GW, transmit and receive discovery signals through the configured discovery channels, and perform reporting a measurement result. That is, each terminal may receive discovery signals through the configured discovery channels, and report measurement result of the received discovery signals to an eNB. The eNB may determine whether D2D communication is possible or not based on the measurement results received from each terminal, and transmit a result of the determination to the P-GW.

Through the above described procedure, if a D2D communication service using Wi-Fi P2P is determined to be provided, a Wi-Fi interface is activated, and a quality of a radio channel between the first terminal and the second terminal may be measured through a procedure of Wi-Fi P2P discovery. If the measured quality of the radio channel is below a threshold value required for performing communications, each terminal may transmit corresponding information to the D2D server through a ProSe WLAN setup response message, and the D2D server which receives the ProSe WLAN setup response message may transfer the result to the P-GW.

Second, the second type of D2D discovery procedure is explained. The P-GW which receives a dedicated EPS bearer setup request from the PCRF may activate a Wi-Fi P2P discovery by interworking with the D2D server (at S212). Then, the P-GW may measure proximity between the first terminal and the second terminal which will perform communications. Specifically, the D2D server may indicate each terminal to activate a Wi-Fi interface and perform a procedure of peer discovery (at S213 and S214). Each terminal which receives the indication may perform the procedure of peer discovery (at S215). After the peer discovery, each terminal may measure a quality of radio channel between each terminal and a counterpart terminal, and transmit a measured result to the D2D server.

After the proximity between terminals is measured through the procedure of D2D discovery, information about the proximity is used for updating a proximity map managed by the D2D server. The proximity map may be used as base information for determining feasibility of D2D communications and D2D discovery later. However, the information of the proximity map may become incorrect according to mobility of a terminal so that the proximity map should be managed in consideration of this possibility.

A Procedure of Determining a Feasibility of WLAN ProSe Communication

After the procedure of D2D discovery, the P-GW may determine whether a service is provided to a session using a WLAN ProSe or using a LTE infrastructure based on the information of D2D discovery (that is, information about proximity between the first terminal and the second terminal) obtained through the procedure of D2D discovery (at S216 and S217).

A Procedure of Configuring a Dedicated EPS Bearer

If it is determined that a service is provided through a LTE infrastructure, the P-GW may configure a dedicated EPS bearer using a LTE infrastructure for a session of the service requested by a terminal. That is, the P-GW may configure a dedicated EPS bearer for the first terminal (at S219) by performing a procedure of configuring a dedicated EPS bearer with the first terminal (at S218). Also, the P-GW may configure a dedicated EPS bearer for the second terminal (at S221) by performing a procedure of configuring a dedicated EPS bearer with the second terminal (at S220).

After the configuration of dedicated EPS bearers, the P-GW may transmit an IP CAN session setup response message in response to the dedicated EPS bearer setup request to the PCRF (at S222).

A Procedure of Configuring WLAN ProSe

On the contrary, if it is determined that a service is provided through a WLAN ProSe, the P-GW may request a ProSe service using WLAN to the D2D server by transmitting a ProSe request message to the D2D server (at S223). When the ProSe request message is received, the D2D server may request a configuration of WLAN ProSe service by transmitting a ProSe WLAN setup request message to each terminal (at S224 and S225).

When the ProSe WLAN setup request message is received, a D2D client module in each terminal may activate a Wi-Fi interface. When the Wi-Fi interface is activated, the D2D client module may perform a procedure of peer discovery and configuring a link (at S226), and transmit a ProSe WLAN setup response message including the result to the D2D server (at S227 and S228).

When the ProSe WLAN setup response message is received from each terminal, the D2D server may transmit a ProSe response message including a result of WLAN ProSe configuration to the P-GW (at S229). When the ProSe response message is received, the P-GW may transmit an IP CAN session setup response message in response to the dedicated EPS bearer configuration request to the PCRF (at S230). When the procedure of configuring WLAN ProSe service is completed, the first terminal and the second terminal may perform communications through application of each.

The above described procedure of configuring WLAN ProSe may be performed differently according to a type of D2D discovery. For example, in a case of the first type of D2D discovery (that is, measuring through ProSe discovery using E-UTRA, and estimating proximity between two terminals based on the measurement), Wi-Fi interfaces of two terminals which will perform D2D communications are activated, and procedures of discovery for Wi-Fi P2P communications and configuring a link are performed. On the contrary, in a case of the second type of D2D discovery (that is, using Wi-Fi P2P peer discovery), a procedure of configuring a link is performed using Wi-Fi interfaces of the two terminals which have been already activated.

Also, in performing configuration of WLAN ProSe, a D2D client module located in each terminal may discover not all terminals but only a counterpart terminal needed for WLAN ProSe communications by using a way of scan filter defined in a Wi-Fi P2P specification. Here, when a type of management of information needed for WLAN ProSe is a type of tight management, a procedure of provisioning can be omitted by using a group owner indication and information related to WPS provided from the D2D server for forming P2P groups. That is, by exchanging information related to WLAN ProSe with terminals in a 3GPP EPS, procedures of communications for Wi-Fi P2P can be simplified and so time needed for configuring Wi-Fi P2P communications can be reduced.

In the second place, a procedure of configuring WLAN ProSe which is performed in the first terminal and the second terminal will be explained in detail.

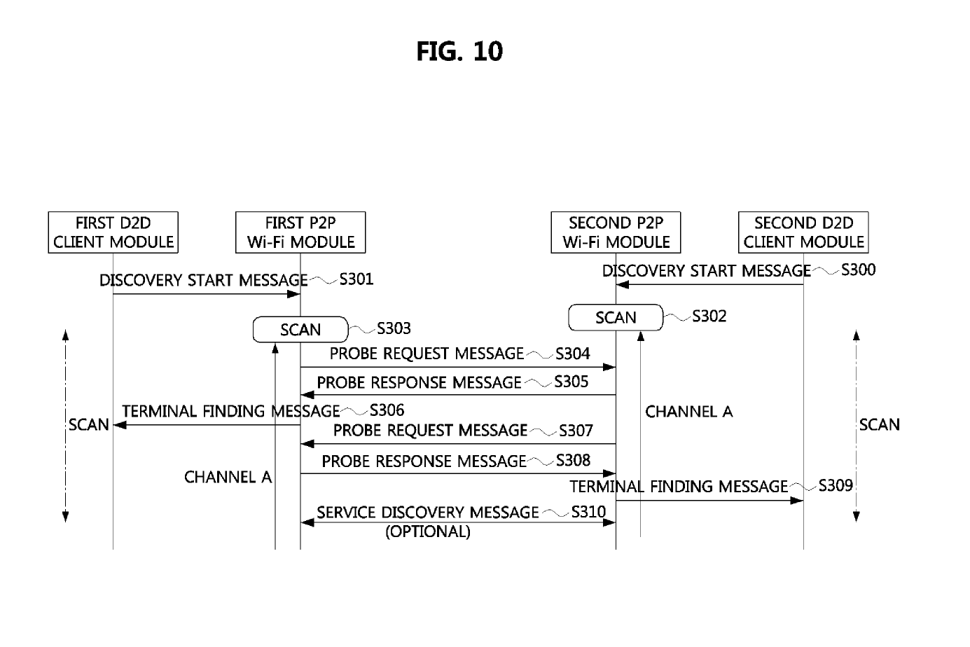

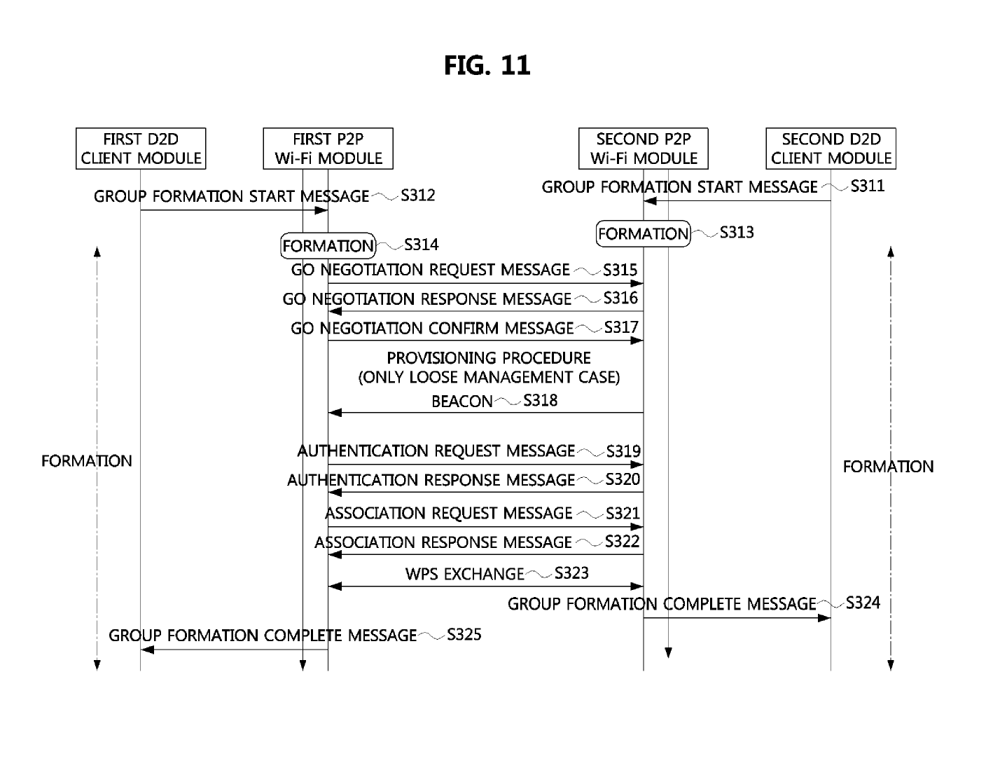

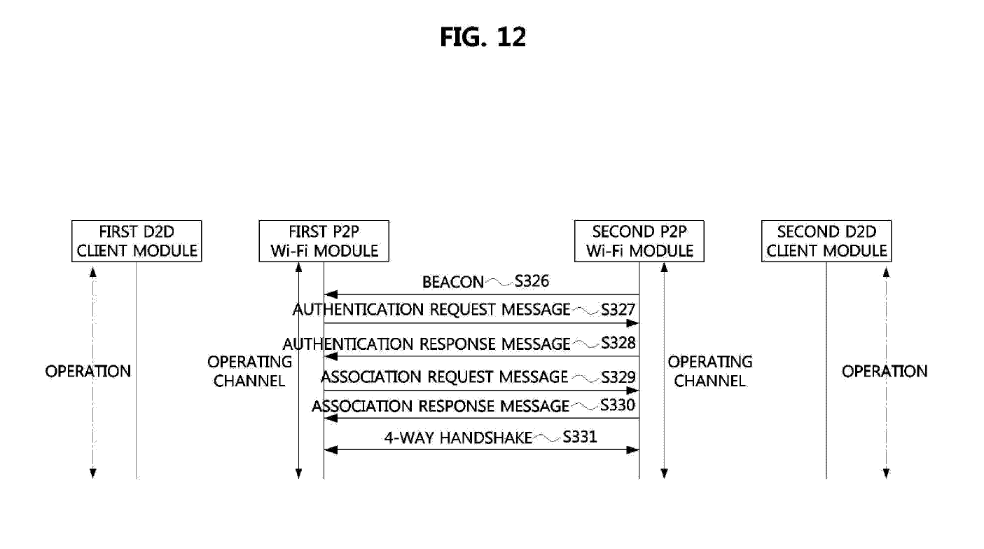

FIG. 10 is a flow chart to explain a first configuration procedure for a Wi-Fi P2P communication according to the present invention, and FIG. 11 is a flow chart to explain a second configuration procedure for a Wi-Fi P2P communication according to the present invention, and FIG. 12 is a flow chart to explain a third configuration procedure for a Wi-Fi P2P communication according to the present invention.

Referring to FIGS. 10 to 12, the first terminal may comprise a first D2D client module and a first P2P Wi-Fi module, and the second terminal may comprise a second D2D client module and a second P2P Wi-Fi module.

First, each D2D client module may transmit a discovery start message to the P2P Wi-Fi module corresponding to it (at S300 and S301). Each P2P Wi-Fi module may perform a procedure of scanning by receiving the discovery start message (at S302 and S303). Here, the discovery start message may include a P2P device ID, a device name, a channel number (for example, a channel ‘A’), a GO intent, etc. The following procedures of scanning and forming groups may be performed in an operating channel indicated by the channel number.

The first P2P Wi-Fi module may transmit a probe request message (at S304), and receive a probe response message in response to the probe request message from the second P2P Wi-Fi module (at S305). Through this, the first P2P Wi-Fi module may discover the second terminal, and transmit a terminal finding message indicating that the second terminal is discovered to the first D2D client module (at S306).

Similarly, the second P2P Wi-Fi module may transmit a probe request message (at S307), and receive a probe response message in response to the probe request message from the first P2P Wi-Fi module (at S308). Through this, the second P2P Wi-Fi module may discover the first terminal, and transmit a terminal finding message indicating that the first terminal is discovered to the second D2D client module (at S309).

Meanwhile, when a counterpart terminal is discovered, the first P2P Wi-Fi module and the second P2P Wi-Fi module may transmit and receive service discovery messages for discovering services to and from each other (at S310). Here, the procedure of transmitting and receiving service discovery messages is optional.

Then, each D2D client module may transmit a group formation start message to each P2P Wi-Fi module (at S311 and S312). Each P2P Wi-Fi module may start a procedure of forming groups by receiving the group formation start message (at S313 and S314).

Each terminal may perform a procedure of transmitting and receiving a GO negotiation request message, a GO negotiation response message, and a GO negotiation confirm message through each P2P Wi-Fi module (at S315, S316, and S317). Through the procedure, the first terminal may be configured as a client, and the second terminal may be configured as a group owner (GO).

When a type of management of information needed for WLAN ProSe is a type of loose management, the first terminal and the second terminal may further perform a procedure of provisioning. Specifically, the second terminal, a group owner, may transmit a beacon through the second P2P Wi-Fi module (at S318). When the beacon is received, the first P2P Wi-Fi module may transmit an authentication request message (at S319) and receive an authentication response message in response to the authentication request message from the second P2P Wi-Fi module (at S320). After a completion of the procedure of authentication, the first P2P Wi-Fi module may transmit an association request message (at S321) and receive an association response message in response to the association request message from the second P2P Wi-Fi module (at S322). After a completion of the procedure of association, the first P2P Wi-Fi module and the second P2P Wi-Fi module may perform a procedure of exchanging WPS (at S323).

When the formation of groups is completed through the above procedures, each P2P Wi-Fi module may transmit a group formation complete message indicating a completion of group formation to the each D2D client module (at S324 and S325).

After a completion of the procedure of group formation, the second P2P Wi-Fi module may transmit a beacon in an operating channel (at S326). When the beacon is received, the first P2P Wi-Fi module may transmit an authentication request message (at 5327) and receive an authentication response message in response to the authentication request message from the second P2P Wi-Fi module (at S328). After a completion of the procedure of authentication, the first P2P Wi-Fi module may transmit an association request message (at S329) and receive an association response message in response to the association request message from the second P2P Wi-Fi module (at S330). After a completion of the procedure of association, the first P2P Wi-Fi module and the second P2P Wi-Fi module may perform a procedure of 4-way handshaking (at S331).

Referring again to FIG. 9, after a completion of a procedure of configuring WLAN ProSe, a procedure of WLAN ProSe measurement may be performed.

A Procedure of WLAN ProSe Measurement

During a WLAN ProSe service, each terminal may perform measurements on a channel used for communicating with a counterpart terminal persistently (at S231 and S232). Each terminal may determine whether states of the channel and quality of service of the service are below a predefined threshold value or not (at S233 and S234).

A Procedure of Changing a Communication Mode from WLAN ProSe Mode to Infrastructure Mode

In the above described procedure of WLAN ProSe measurement, when states of the channel and quality of service of the service are below a predefined threshold value, each terminal may transmit a path switch request message to the D2D server (at S235 and S236). When the patch switch request message is received from a terminal in a state of WLAN ProSe, the D2D server may request a change of path for a session by transmitting a path switch required message to the P-GW (at S237). When the request of the change of path is received, the P-GW may perform a procedure of configuring a dedicated EPS bearer based on an infrastructure mode for the corresponding session (at S238 and S240), and configure dedicated EPS bearer for each terminal (at S239 and S241). After a completion of the configuration of the dedicated EPS bearers, the P-GW may transmit a path switch complete message in response to the path switch request message to the D2D server (at S242), and perform a procedure of an IP CAN session modification for the corresponding session by interworking with the PCRF (at S243).

Meanwhile, when the path switch complete message is received, the D2D server may transmit a path switch response message in response to the path switch request message to each terminal (at S244 and S245). Each terminal may perform a procedure of releasing a Wi-Fi P2P link in response to the path switch complete message (at S246).

Next, operation procedures for management and continuity of services of a ProSe assisted WLAN direct communication are explained.

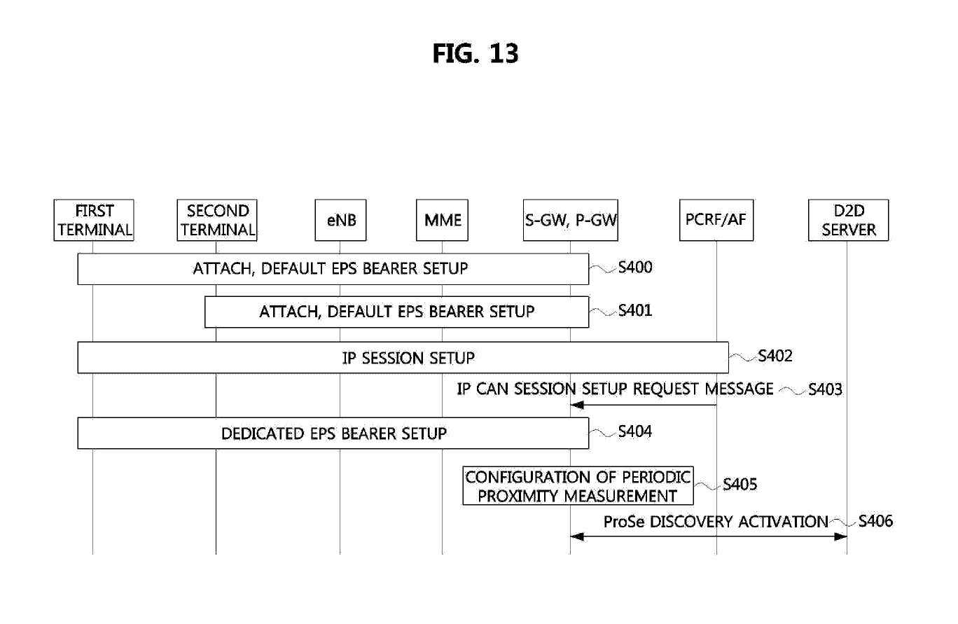

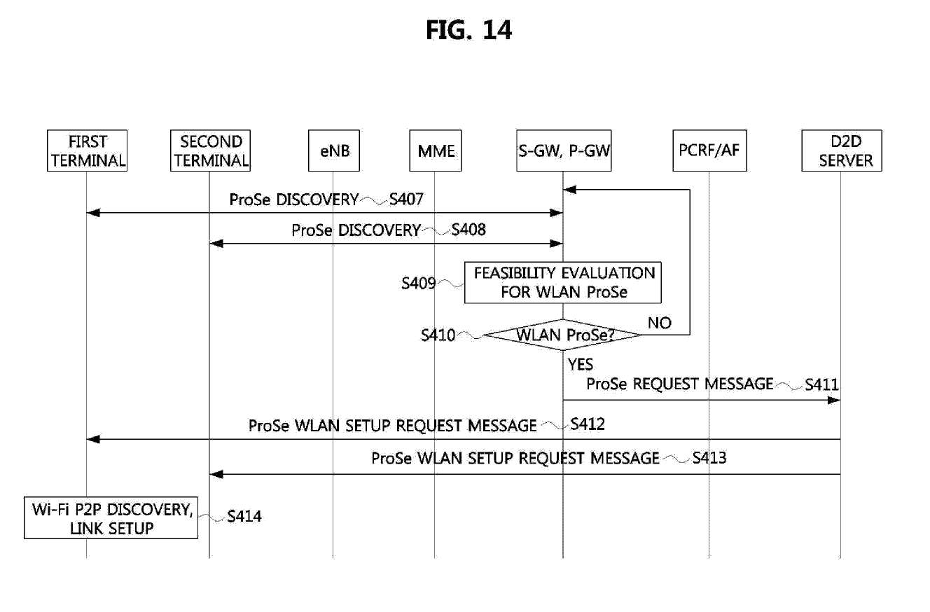

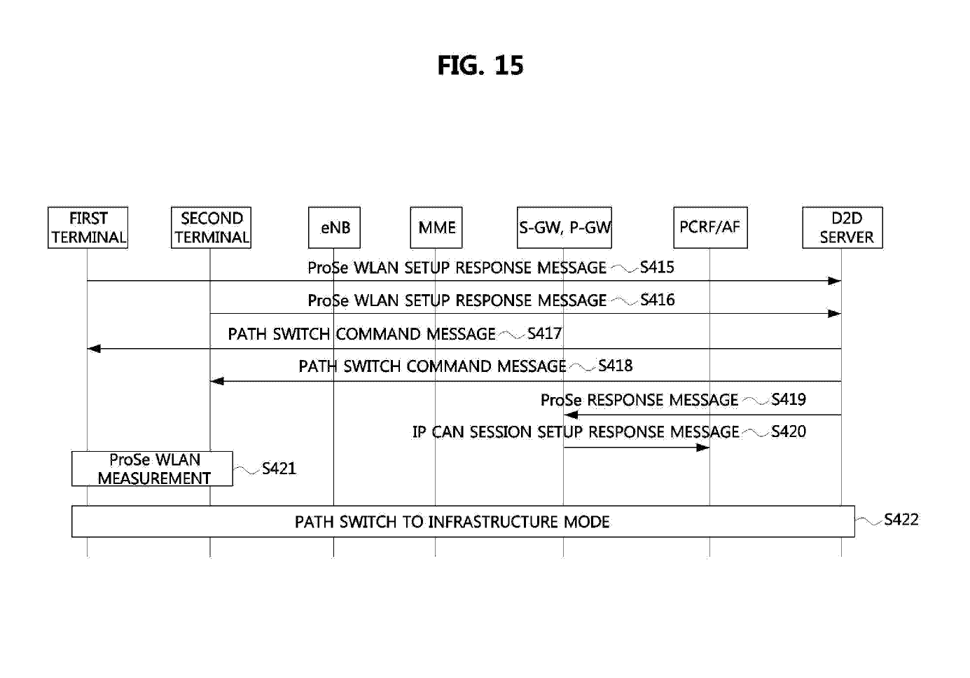

FIG. 13 is a flow chart to explain a first operation procedure for management and continuity of services of a ProSe assisted WLAN direct communication according to the present invention, and FIG. 14 is a flow chart to explain a second operation procedure for management and continuity of services of a ProSe assisted WLAN direct communication according to the present invention, and FIG. 15 is a flow chart to explain a third operation procedure for management and continuity of services of a ProSe assisted WLAN direct communication according to the present invention.

Referring to FIGS. 13 to 15, the operation procedures for management and continuity of services mean procedures providing a specific service or entire services flexibly by using an infrastructure mode or a WLAN ProSe mode according to a communication environment in a state in which the first terminal and the second terminal are registered. In order to support the procedures for management and continuity of services, a 3GPP EPS should have a function of traffic switching between an infrastructure mode and a WLAN ProSe mode.

Procedures of Attachment and Configuration of a Default EPS Bearer

Each terminal may perform a procedure of attachment and a procedure of configuring a default EPS bearer by interworking with the P-GW (at S400 and S401). The procedures for the first terminal may be identical to those which were explained in the steps S200 to S202 by referring to FIG. 7. The procedures for the second terminal may be identical to those which were explained in the steps S203 to S205 by referring to FIG. 7.

Procedures of Configuring an IP-Level Session

After the default EPS bearer is configured, the first terminal and the second terminal may configure a session with a PCRF/AF (application function) based on an IP level protocol such as a session initiation protocol (SIP) (at S402). In this case, the first terminal may perform a procedure of session configuration by interworking with the second terminal. The procedure for the first terminal may be identical to the procedure explained in the step S206 by referring to FIG. 7, and the procedure for the second terminal may be identical to the procedure explained in the step S207 by referring to FIG. 7.

A Procedure of Requesting a Dedicated EPS Bearer Configuration

Then, the PCRF may transmit an IP CAN session setup request message to the P-GW in order to request configuration of a dedicated EPS bearer according to the IP level session configuration request (at S403). The procedure may be identical to the procedure explained in the step S208 by referring to FIG. 7.

A Procedure of Configuring a Dedicated EPS Bearer

When the IP CAN session setup request message is received, the P-GW may configure a dedicated EPS bearer using a LTE infrastructure (at S404). The procedure for configuring a dedicated EPS bearer for the first terminal may be identical to those which were explained in the steps S218 and S219 by referring to FIG. 8. The procedure for configuring a dedicated EPS bearer for the second terminal may be identical to those which were explained in the steps S220 and S221 by referring to FIG. 8.

A Procedure of Periodic D2D Discovery

When the dedicated EPS bearers for the first terminal and the second terminal have been configured, the P-GW may perform a procedure of D2D discovery by interworking with the D2D server, the first terminal, and the second terminal periodically (at S405, S406, S407, and S408). The procedure of D2D discovery means a procedure of measuring proximity between two terminals desiring to perform a WLAN ProSe service. The procedure of D2D discovery may be identical to that which was explained in the steps S209 to S215 by referring to FIG. 7.

A Procedure of Determining a Feasibility of WLAN ProSe Communication

After the procedure of D2D discovery, the P-GW may determine whether a service is provided to a session using a WLAN ProSe or is provided to a session using a LTE infrastructure based on the information of D2D discovery (that is, information about a proximity between the first terminal and the second terminal) obtained through the procedure of D2D discovery (at S409 and S410). If it is determined that a service is provided through a LTE infrastructure, the P-GW may maintain a currently configured path. On the contrary, if it is determined that a service is provided through a WLAN ProSe, a procedure of configuring WLAN ProSe and a procedure of path switching may be performed.

A Procedure of Configuring WLAN ProSe and a Procedure of Path Switching

When it is determined that a service is provided through a WLAN ProSe, the P-GW may request a ProSe service using WLAN to the D2D server by transmitting a ProSe request message to the D2D server (at S411). When the ProSe request message is received, the D2D server may request a configuration of WLAN ProSe service by transmitting a ProSe WLAN setup request message to each terminal (at S412 and S413).

When the ProSe WLAN setup request message is received, each terminal may activate a Wi-Fi interface, and perform a procedure of peer discovery and configuring a link through the activated Wi-Fi interface (at S414). Then, each terminal may transmit a ProSe WLAN setup response message including the result to the D2D server (at S415 and S416).

When the ProSe WLAN setup response message is received, the D2D server may indicate a path switching by transmitting a path switch command message to each terminal (at S417 and S418). After indicating a path switching to each terminal, the D2D server may transmit a ProSe response message in response to the ProSe request message to the P-GW (at S419). When the ProSe response message is received, the P-GW may transmit an IP CAN session setup response message to the PCRF, and perform a procedure of IP CAN modification by interworking with the PCRF (at S420).

A Procedure of WLAN ProSe Measurement

During a WLAN ProSe service, each terminal may perform measurements on a channel used for communicating with a counterpart terminal persistently, and determine whether states of the channel and quality of service of the service are below a predefined threshold value or not (at S421). The procedure may be identical to the steps S231 to S234 which were explained by referring to FIG. 9.

A Procedure of Changing WLAN ProSe Mode to Infrastructure Mode

In the above described procedure of WLAN ProSe measurement, when states of the channel and quality of service of the service are below a predefined threshold value, each terminal may perform a mode change procedure by interworking with the PGW, the D2D server, etc. (at S422). The procedure of changing mode may be identical to the steps S235 to S246 which were explained by referring to FIG. 9.

In the second place, an operation procedure in which an E-UTRAN infrastructure mode and a WLAN ProSe mode operate simultaneously is explained.

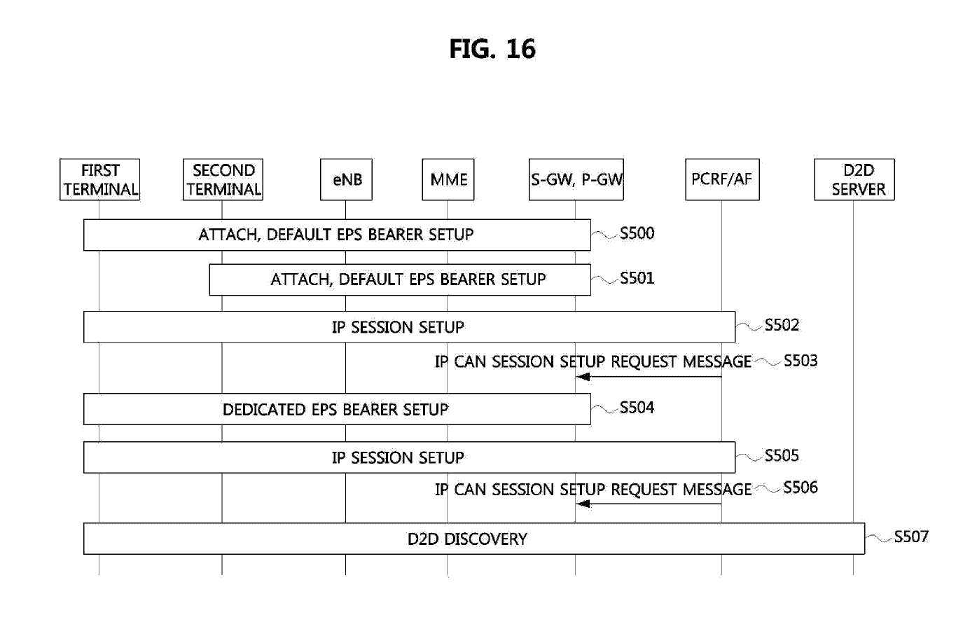

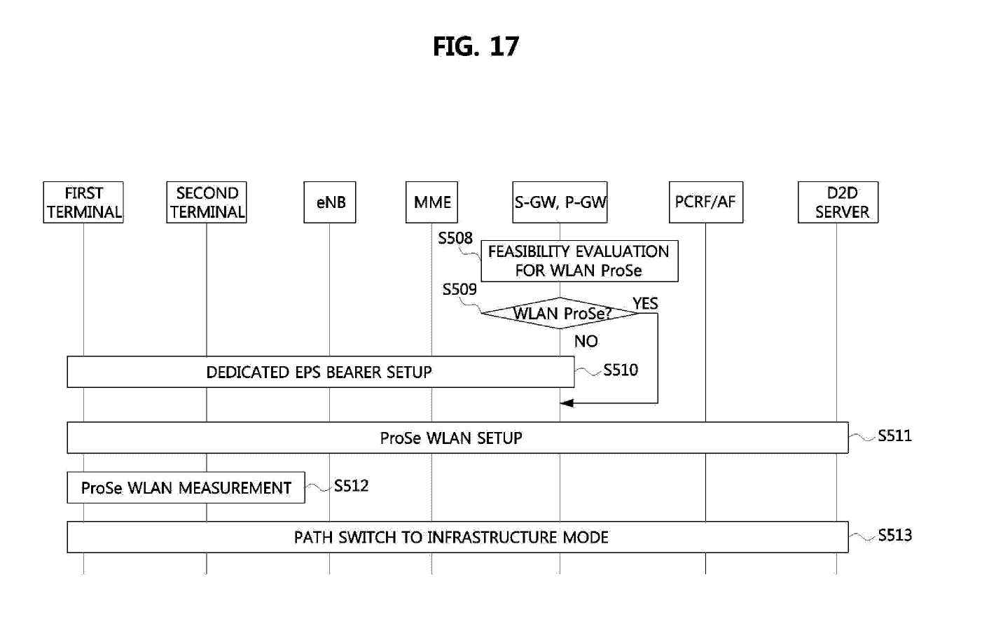

FIG. 16 is a flow chart to explain a first simultaneous operation procedure for an E-UTRAN infrastructure mode and a WLAN ProSe mode according to the present invention, and FIG. 17 is a flow chart to explain a second simultaneous operation procedure for an E-UTRAN infrastructure mode and a WLAN ProSe mode according to the present invention.

Referring to FIGS. 16 and 17, the simultaneous operation procedure of an E-UTRAN infrastructure mode and a WLAN ProSe mode is a procedure in which a service is provided by using an E-UTRAN infrastructure mode and a WLAN ProSe mode simultaneously according to characteristics of the service and situations of a network in a state that the first terminal and the second terminal are registered.

Procedures of Attachment and Configuration of a Default EPS Bearer

Each terminal may perform a procedure of attachment and a procedure of configuring a default EPS bearer by interworking with the P-GW (at S500 and S501). The procedures for the first terminal may be identical to those which were explained in the steps S200 to S202 by referring to FIG. 7. The procedures for the second terminal may be identical to those which were explained in the steps S203 to S205 by referring to FIG. 7.

Procedures of Configuring an IP-Level Session (a First Session)

After the default EPS bearer is configured, the first terminal and the second terminal may configure a first session with a PCRF/AF (application function) based on an IP level protocol such as a session initiation protocol (SIP) (at S502). In this case, the first terminal may perform a procedure of configuring the first session by interworking with the second terminal. The procedure for the first terminal may be identical to the procedure explained in the step S206 by referring to FIG. 7, and the procedure for the second terminal may be identical to the procedure explained in the step S207 by referring to FIG. 7.

A Procedure of Requesting a Dedicated EPS Bearer Configuration (a First Session)

Then, the PCRF may transmit an IP CAN session setup request message to the P-GW in order to request configuration of a dedicated EPS bearer according to the IP level session configuration request (at S503). The procedure may be identical to the procedure explained in the step S208 by referring to FIG. 7.

A Procedure of Configuring a Dedicated EPS Bearer (a First Session)

When the IP CAN session setup request message is received, the P-GW may configure a dedicated EPS bearer using a LTE infrastructure (at S504). The procedure for configuring a dedicated EPS bearer for the first terminal may be identical to those which were explained in the steps S218 and S219 by referring to FIG. 8. The procedure for configuring a dedicated EPS bearer for the second terminal may be identical to those which were explained in the steps S220 and S221 by referring to FIG. 8.

Procedures of Configuring an IP Level Session (a Second Session)

After the default EPS bearer for the first session is configured, the first terminal and the second terminal may configure a second session with a PCRF/AF (application function) based on an IP level protocol such as a session initiation protocol (SIP) (at S505). In this case, the first terminal may perform a procedure of session configuration by interworking with the second terminal. The procedure for the first terminal may be identical to the procedure explained in the step S206 by referring to FIG. 7, and the procedure for the second terminal may be identical to the procedure explained in the step S207 by referring to FIG. 7.

A Procedure of Requesting a Dedicated EPS Bearer Configuration (a Second Session)

Then, the PCRF may transmit an IP CAN session setup request message to the P-GW in order to request configuration of a dedicated EPS bearer according to the IP level session configuration request (at S506). The procedure may be identical to the procedure explained in the step S208 by referring to FIG. 7.

A Procedure of D2D Discovery

After the procedure of requesting a configuration of a dedicated EPS bearer for the second session, the procedure of D2D discovery may be performed (at S507). The procedure of D2D discovery means a procedure of measuring a proximity between two terminals (that is, the first terminal and the second terminal) desiring to perform a ProSe service, and may be performed by the D2D server according to a request of the P-GW. The procedure of D2D discovery may be classified into two types. A first type is a type of performing measurement through a ProSe discovery using E-UTRA and measuring proximity between two terminals based on the measurement. The second type is a type of using a peer discovery of Wi-Fi P2P.

The procedure of D2D discovery based on the first type may be identical to the steps S209 to S211 which were explained by referring to FIG. 7. On the contrary, the procedure of D2D discovery based on the second type may be identical to the steps S212 to S215 which were explained by referring to FIG. 7.

A Procedure of Determining a Feasibility of WLAN ProSe Communication

After the procedure of D2D discovery, the P-GW may determine whether a service is provided to a session using a WLAN ProSe or is provided to a session using a LTE infrastructure based on the information of D2D discovery (that is, information about a proximity between the first terminal and the second terminal) obtained through the procedure of D2D discovery (at S508 and S509). If it is determined that a service is provided through a WLAN ProSe, a procedure of configuring WLAN ProSe may be performed as a next step.

A Procedure of Configuring a Dedicated EPS Bearer (a Second Session)

If it is determined that a service is provided through a LTE infrastructure, the P-GW may configure a dedicated EPS bearer using a LTE infrastructure (at S510). The procedure for configuring a dedicated EPS bearer for the first terminal may be identical to those which were explained in the steps S218 and S219 by referring to FIG. 8. The procedure for configuring a dedicated EPS bearer for the second terminal may be identical to those which were explained in the steps S220 and S221 by referring to FIG. 8.

A Procedure of Configuring WLAN ProSe

When it is determined that a service is provided through a WLAN ProSe, the P-GW may perform a WLAN ProSe by interworking with the D2D server, the first terminal, and the second terminal (at S511). The procedure of configuring WLAN ProSe may be identical to the steps S223 to S230 which were explained by referring to FIG. 7.

A Procedure of WLAN ProSe Measurement

During a WLAN ProSe service, each terminal may perform measurements on a channel used for communicating with a counterpart terminal persistently, and determine whether states of the channel and quality of service of the service are below a predefined threshold value or not (at S512). The procedure may be identical to the steps S231 to S234 which were explained by referring to FIG. 9.

A Procedure of Changing WLAN ProSe Mode to Infrastructure Mode

In the above described procedure of WLAN ProSe measurement, when states of the channel and quality of service of the service are below a predefined threshold value, each terminal may perform a mode change procedure by interworking with the PGW, the D2D server, etc. (at S513). The procedure of changing mode may be identical to the steps S235 to S246 which were explained by referring to FIG. 9.

Hereinafter, an operation procedure for network offloading through a WLAN ProSe communication will be explained.

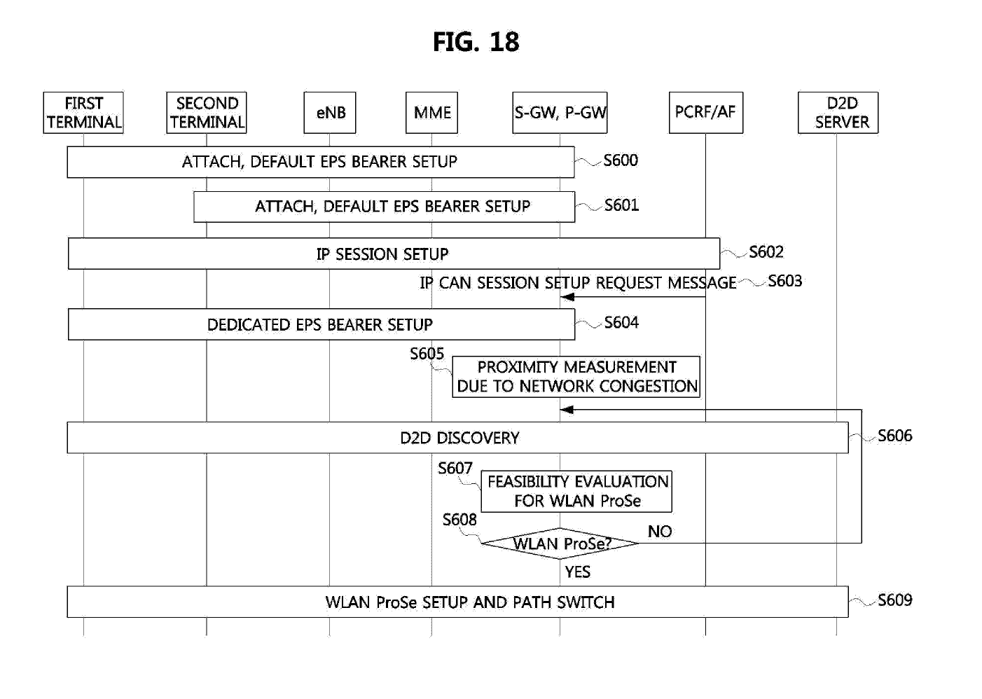

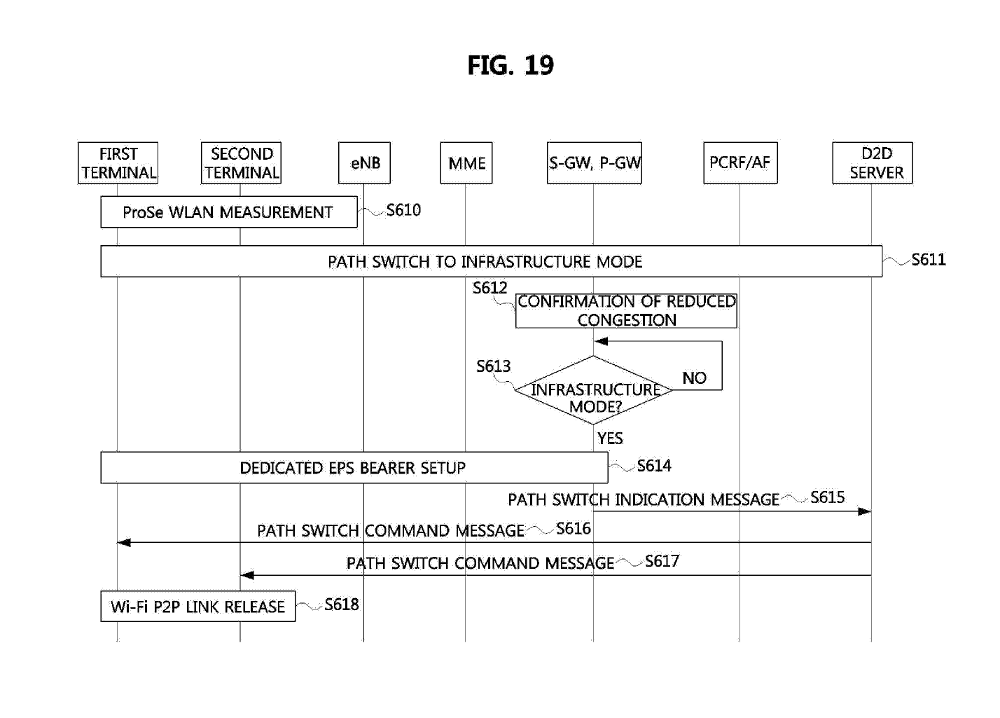

FIG. 18 is a flow chart to explain a first operation procedure for network offloading through a WLAN ProSe communication according to the present invention, and FIG. 19 is a flow chart to explain a second operation procedure for network offloading through a WLAN ProSe communication according to the present invention.

Referring to FIGS. 18 and 19, an operation procedure for network offloading means a procedure in which a specific service or entire services are provided through an E-UTRAN infrastructure mode or a WLAN ProSe mode selectively according to load states of a LTE network in a state that the first terminal and the second terminal are registered. Also, the operation procedure may include a procedure of changing a mode of a service session from an infrastructure mode to a WLAN ProSe mode for terminals with capabilities of WLAN ProSe when load of the LTE network becomes higher. Also, the operation procedure may include a procedure of changing a mode of a service session from a WLAN ProSe mode to an infrastructure mode when load of the LTE network becomes lower.

Procedures of Attachment and Configuration of a Default EPS Bearer

Each terminal may perform a procedure of attachment and a procedure of configuring a default EPS bearer by interworking with the P-GW (at S600 and S601). The procedures for the first terminal may be identical to those which were explained in the steps S200 to S202 by referring to FIG. 7. The procedures for the second terminal may be identical to those which were explained in the steps S203 to S205 by referring to FIG. 7.

Procedures of Configuring an IP-Level Session

After the default EPS bearer is configured, the first terminal and the second terminal may configure a first session with a PCRF/AF (application function) based on an IP level protocol such as a session initiation protocol (SIP) (at S602). In this case, the first terminal may perform a procedure of configuring the first session by interworking with the second terminal. The procedure for the first terminal may be identical to the procedure explained in the step S206 by referring to FIG. 7, and the procedure for the second terminal may be identical to the procedure explained in the step S207 by referring to FIG. 7.

A Procedure of Requesting a Dedicated EPS Bearer Configuration

Then, the PCRF may transmit an IP CAN session setup request message to the P-GW in order to request configuration of a dedicated EPS bearer according to the IP level session configuration request (at S603). Here, the session configuration of which is requested may mean a session which can use a WLAN ProSe mode according to user preferences, policies of a MNO, etc. when the load of LTE network becomes higher.

A Procedure of Configuring a Dedicated EPS Bearer

When the request of the configuration of a dedicated EPS bearer is received, the P-GW may configure a dedicated EPS bearer using a LTE infrastructure (at S604). The procedure for configuring a dedicated EPS bearer for the first terminal may be identical to those which were explained in the steps S218 and S219 by referring to FIG. 8. The procedure for configuring a dedicated EPS bearer for the second terminal may be identical to those which were explained in the steps S220 and S221 by referring to FIG. 8.

A Procedure of Determining Measurement of Proximity According to Increase of Traffic Load

When the configuration of the dedicated EPS bearer is completed, the P-GW may determine whether to start measurement of a proximity based on load of the LTE network (at S605). If the load of the LTE network is above a predefined threshold, the PGW may start a procedure of proximity measurement to discover terminals with which can perform WLAN ProSe services.

A Procedure of D2D Discovery

When the procedure of proximity measurement is determined to be started, a procedure of D2D discovery may be performed (at S606). The procedure of D2D discovery means a procedure of measuring a proximity between two terminals (that is, the first terminal and the second terminal) desiring to perform a ProSe service, and may be performed by the D2D server according to a request of the P-GW. The procedure of D2D discovery may be classified into two types. A first type is a type of performing measurement through a ProSe discovery using E-UTRA and measuring proximity between two terminals based on the measurement. The second type is a type of using a peer discovery of Wi-Fi P2P.

The procedure of D2D discovery based on the first type may be identical to the steps S209 to S211 which were explained by referring to FIG. 7. On the contrary, the procedure of D2D discovery based on the second type may be identical to the steps S212 to S215 which were explained by referring to FIG. 7.

A Procedure of Determining a Feasibility of WLAN ProSe Communication

After the procedure of D2D discovery, the P-GW may determine whether a service is provided to a session using a WLAN ProSe or is provided to a session using a LTE infrastructure based on the information of D2D discovery (that is, information about a proximity between the first terminal and the second terminal) obtained through the procedure of D2D discovery (at S607 and S608). If it is determined that a service is provided through a WLAN ProSe, a procedure of configuring WLAN ProSe may be performed as a next step.

A Procedure of Configuring WLAN ProSe and a Procedure of Path Switching

The P-GW may perform a procedure of configuring WLAN ProSe and a procedure of path switching by interworking with the D2D server, the first terminal, and the second terminal (at S609). The procedures may be identical to the steps S411 to S420 which were explained by referring to FIGS. 14 and 15.

After a communication mode is changed to a WLAN ProSe mode, the communication mode may be changed again to an LTE infrastructure mode in following two manners. The first manner is a manner that the communication mode is changed to an LTE infrastructure mode based on a result of WLAN ProSe measurement.

A Procedure of WLAN ProSe Measurement

During a WLAN ProSe service, each terminal may perform measurements on a channel used for communicating with a counterpart terminal persistently, and determine whether states of the channel and quality of service of the service are below a predefined threshold value or not (at S610). The procedure may be identical to the steps S231 to S234 which were explained by referring to FIG. 9.

A Procedure of Changing WLAN ProSe Mode to Infrastructure Mode

In the above described procedure of WLAN ProSe measurement, when states of the channel and quality of service of the service are below a predefined threshold value, each terminal may perform a mode change procedure by interworking with the PGW, the D2D server, etc. (at S611). The procedure of changing mode may be identical to the steps S235 to S246 which were explained by referring to FIG. 9.

The second manner is that the communication mode is changed to an LTE infrastructure mode based on a result of network traffic monitoring.

A Procedure of Changing into Infrastructure Mode According to Decrease of Traffic Load

During a WLAN ProSe service, the P-GW may check whether traffic of an LTE infrastructure decreases or not (at S612), and determine to change the communication mode to an LTE infrastructure mode according to the decrease of traffic load (at S613).

A Procedure of Configuring a Dedicated EPS Bearer

When the communication mode is determined to be changed from a WLAN ProSe mode to an LTE infrastructure mode, the P-GW may configure a dedicated EPS bearer using a LTE infrastructure (at S614). The procedure for configuring a dedicated EPS bearer for the first terminal may be identical to those which were explained in the steps S218 and S219 by referring to FIG. 8. The procedure for configuring a dedicated EPS bearer for the second terminal may be identical to those which were explained in the steps S220 and S221 by referring to FIG. 8.

A Procedure of Confirming Path Switching

When the procedure of configuring the dedicated EPS bearer is completed, the P-GW may transmit a path switch indication message to the D2D server for confirming path switching (at S615). When the path switch indication message is received, the D2D server may instruct a path switching by transmitting a path switch command message to each terminal (at S616 and S617). When the path switch command message is received, each terminal may perform a procedure of releasing a Wi-Fi P2P link (at S618).

Hereinafter, protocol messages used in the above-described operation procedures for the WLAN ProSe and information elements included in the protocol messages will be explained.

The protocol messages for the WLAN ProSe service are summarized as following table 3.

TABLE 3

| | | Information Elements related |
|---|---|---|
| Protocol message | Description | to WLAN ProSe |
| IP CAN session setup | Requesting configuration of | Characteristics of a session |
| request message | a bearer to an EPS based on | QoS profile demanded |
| | information requested in IP | |
| | session configuration | |
| | PCRF→P-GW | |
| IP CAN session setup | Response on configuration | Result |
| response message | of a bearer for the requested | |
| | IP session configuration | |
| ProSe request message | Requesting ProSe service | Terminal ID |
| | P-GW→D2D server | Session ID |
| | | Session profile |
| | | Operation mode |
| ProSe response message | Response on ProSe service | Result |
| | request | |
| | D2D server→P-GW | |
| ProSe WLAN setup request | Requesting configuration for | Session ID |
| message | ProSe WLAN service | Session profile |
| | D2D server→Terminal | Wi-Fi P2P configuration |
| | | profile |
| ProSe WLAN setup response | Response on configuration | Result |
| message | for ProSe WLAN service | |
| | Terminal→D2D server | |
| Path switch request message | Requesting path switching | Session ID |
| | Terminal→D2D server | |
| Path switch response | Response on path switching | Result |
| message | D2D server→Terminal | |
| Path switch required message | Demanding path switching | Terminal ID |
| | D2D server→P-GW | Session ID |
| | | Cause |
| Path switch complete | Indicating completion of | Result |
| message | path switching | |
| | P-GW→D2D server | |
| Path switch indication | Confirming path switching | Terminal ID |
| message | P-GW→D2D server | Session ID |
| Path switch command | Commanding path | Session ID |
| message | switching | Operation mode |
| | D2D server→Terminal | |

Also, the information elements included in the protocol messages are summarized as a following table 4.

TABLE 4

| Information Element | Description |
|---|---|
| Session characteristic | Demanded characteristics of a session |
| | Operation policy (by a user/by a MNO) |
| Terminal ID | Identifier of a terminal |
| Demanded QoS profile | QoS profile of a demanded service |
| Session ID | Identifier of a session |
| Session profile | Profile related to a session |
| | demanded QoS profile |
| | five tuples for a session |
| Operation mode | Operation mode |
| | Infrastructure mode |
| | WLAN ProSe mode |
| Wi-Fi P2P configuration | Wi-Fi P2P configuration information |
| profile | Wi-Fi operation mode (802.11a/g/n) |
| | SSID |
| | P2P device ID |
| | GO indicator |
| | Credential for Wi-Fi P2P |
| | Channel information and frequency |
| | band for Wi-Fi P2P configuration |
| Cause | Cause code |
| Result | Result of an operation |
| | Success |
| | Failure |

As described above, according to the present invention, D2D communications using a Wi-Fi P2P may be supported efficiently.

While the example embodiments of the present invention and their advantages have been described in detail, it should be understood that various changes, substitutions and alterations may be made herein without departing from the scope of the invention.

What is claimed is:

1. A method for device-to-device communications performed in a first terminal, the method comprising:
configuring a default bearer by interworking with a core network supporting a cellular communication;
configuring a session by interworking with the core network;
discovering a counterpart terminal performing device-to-device communications with the first terminal based on a request of configuring a dedicated bearer; and
configuring a communication path according to a communication mode determined based on a result of the discovering.

2. The method of claim 1, wherein the session is configured based on a session initiation protocol (SIP).

3. The method of claim 1, wherein the first terminal discovers the counterpart terminal performing device-to-device communications with the first terminal based on a cellular communication manner.

4. The method of claim 1, wherein the first terminal discovers the counterpart terminal performing device-to-device communications with the first terminal based on a wireless local area network (WLAN) peer-to-peer (P2P) communication manner.

5. The method of claim 1, wherein the communication path is configured with the dedicated bearer for the cellular communication when the communication mode is a cellular communication mode.

6. The method of claim 1, wherein the communication path is configured with a link for a wireless local area network (WLAN) peer-to-peer (P2P) communication when the communication mode is a WLAN P2P mode.

7. The method of claim 6, further comprising:
measuring a communication quality of the link;
requesting a change of the communication path to a device-to-device server located in the core network when the communication quality is below a predetermined threshold; and
changing the communication path from the link for the WLAN P2P to the dedicated bearer for the cellular communication by interworking with the core network.

8. A method for device-to-device communication performed in a first terminal, the method comprising:
configuring a default bearer by interworking with a core network supporting cellular communication;
configuring a session and a dedicated bearer by interworking with the core network;
discovering a counterpart terminal performing device-to-device communications with the first terminal based on a request of discovery; and
configuring a link for wireless local area network peer-to-peer communications with the counterpart terminal when a communication mode determined according to a result of the discovering is a wireless local area network peer-to-peer communication mode.

9. The method of claim 8, wherein the first terminal discovers the counterpart terminal performing device-to-device communications with the first terminal based on a cellular communication manner.

10. The method of claim 8, wherein the first terminal discovers the counterpart terminal performing device-to-device communications with the first terminal based on a wireless local area network (WLAN) peer-to-peer (P2P) communication manner.

11. The method of claim 8, further comprising:
measuring a communication quality of the link; and
changing the communication path from the link for the WLAN P2P to the dedicated bearer for the cellular communication when the communication quality is below a predetermined threshold.

12. A method for device-to-device communication performed in a first terminal, the method comprising:
configuring a default bearer by interworking with a core network supporting cellular communication;
configuring a first session and a first dedicated bearer by interworking with the core network;
configuring a second session by interworking with the core network;
discovering a counterpart terminal performing device-to-device communications with the first terminal based on a request of configuring a second dedicated bearer; and
configuring a communication path according to a communication mode determined based on a result of the discovering.

13. The method of claim 12, wherein the first terminal discovers the counterpart terminal performing device-to-device communications with the first terminal based on a cellular communication manner.

14. The method of claim 12, wherein the first terminal discovers the counterpart terminal performing device-to-device communications with the first terminal based on a wireless local area network (WLAN) peer-to-peer (P2P) communication manner.

15. The method of claim 12, wherein the communication path is configured with the dedicated bearer for the cellular communication when the communication mode is a cellular communication mode.

16. The method of claim 12, wherein the communication path is configured with a link for a wireless local area network (WLAN) peer-to-peer (P2P) communication when the communication mode is a WLAN P2P mode.

17. The method of claim 16, further comprising:
measuring a communication quality of the link; and
changing the communication path from the link for the WLAN P2P to the second dedicated bearer for the cellular communication when the communication quality is below a predetermined threshold.

18. A method for device-to-device communication performed in a first terminal, the method comprising:
configuring a default bearer by interworking with a core network supporting cellular communication;
configuring a session and a dedicated bearer by interworking with the core network;
discovering a counterpart terminal performing device-to-device communications with the first terminal when a traffic load of the cellular communication is equal to or above a predetermined threshold; and
configuring a link for wireless local area network peer-to-peer communications with the counterpart terminal when a communication mode determined according to a result of the discovering is a wireless local area network peer-to-peer communication mode.

19. The method of claim 18, further comprising:
measuring a communication quality of the link; and
changing the communication path from the link for the WLAN P2P to the dedicated bearer for the cellular communication when the communication quality is below a predetermined threshold.

20. The method of claim 18, further comprising:
changing the communication path from the link for the WLAN P2P to the dedicated bearer for the cellular communication when a traffic load of the cellular communication is below a predetermined threshold.
